(19) United States
(12) Patent Application Publication
(10) Pub. No.: US 2010/0307325 A1
(43) Pub. Date: Dec. 9, 2010

(54) GUITAR, TUNER, AMPLIFIER AND EFFECTS CIRCUIT, CABLES AND CASE

(76) Inventor: Christopher T. Appel, New York, NY (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/794,316

(22) Filed: Jun. 4, 2010

Related U.S. Application Data
(60) Provisional application No. 61/184,223, filed on Jun. 4, 2009.

(51) Int. Cl. G10H 1/32; G10G 5/00

(52) U.S. Cl. 84/743; 84/327

(57) ABSTRACT

A system for playing music includes an guitar with two audio output channels, a cable to connect to the two output channels to an amplifier, an amplifier having two channels, an effects apparatus, and a guitar tuner mounted within the guitar. A looping circuit is connected to record instrument performances and play a looped playback of the performance, permitting the performer to accompany his earlier performance. Multiple channel looping circuits are provided. A guitar strap is provided with a vocal microphone that is connected through the strap end for amplifying the vocal signal. An alternate guitar strap includes an instrument input, an amplifier, battery and speaker positioned near the player's ear.

### CROSS-REFERENCE TO RELATED APPLICATION

This application claims the benefit of U.S. Provisional Patent Application Ser. No. 61/184,223, filed Jun. 4, 2009, which is incorporated by reference herein.

### BACKGROUND OF THE INVENTION

1. Field of the Invention

The present invention relates generally to a system for performing music, wherein the system includes one or more of an electric guitar having a stereo output, stereo cables for the guitar, a recording and playback looping circuit, an amplifier for receiving the stereo signal from the guitar and outputting an amplified signal. The system may also include a case for the guitar, a tuner within the guitar, a vocal microphone looping circuit within the guitar, a plate reverb tone effects apparatus, and tube amplifier.

2. Description of the Related Art

Amplified musical instruments have been in wide use for some time. The electrical signal from a guitar or other instrument can be processed using various effects processors prior to or in conjunction with amplification to create many different sounds, aural textures, moods, etc. A typical system for an amplified guitar in which the player is using audio effects includes a guitar with one or more pickups in or mounted to the guitar body, one or more effects processors connected to the guitar via a cable, an amplifier connected to the effects processors via a cable, and possibly a speaker cabinet connected to the amplifier. The amplifier and speaker may be contained in the same cabinet.

Guitar players are frequently searching for new and different aural effects and tones from the instrument while playing. The most common approach has been to use standard guitars having a single output signal and feed that output signal into amplifiers and effects devices that generate the different effects and tones. Music stores and guitar stores carry a wide line of effects processors, some as small boxes connected in daisy chain fashion between the guitar and the amplifier and others as panels or boards that include many different selectable effects. Amplifiers also are provided with tone controls including controls to change the drive of one or more stages of the preamplifier to achieve, for example, an overdriven tone, as well as controls that vary the relative amplitude of frequency bands. Some guitar amplifiers have the effects devices built into the amplifier housing. Nevertheless, the sounds are the result of a single input into the system from the single guitar output signal.

### SUMMARY OF THE INVENTION

The present invention provides a guitar having a stereo output so that two different signals are generated by the guitar. The guitar is an element of a system that uses the stereo output from the guitar for performances or recording, the system including the guitar, guitar cables to connect the stereo signal to an amplifier, an amplifier that receives and amplifies the stereo signal, and recording and playback looping circuits that permit the guitar player to record a performance and play it back while accompanying himself or herself.

Additional features of the present music performance system include a vocal recording and playback looping circuit, a guitar tuner mounted within the guitar, a vocal microphone built into the guitar strap, an amplifier and speaker built into the guitar strap, a reverberation effects apparatus for effecting the tone of the guitar sound, and an improved case to carry and store the guitar. The system may include one or more battery powered amplifiers which operates without requiring an external power supply. Various embodiments of amplifiers are provided, including a tube amplifier providing a clean, clear sound from the guitar output. The microphone built into the guitar strap enables the guitarist to amplify his or her voice and sing to accompany the guitar playing without requiring a separate microphone or microphone stand. Another feature of the system is a guitar tuner mounted within the guitar, enabling the guitarist to tune the guitar without unplugging the guitar from the amplifier and without requiring a separate tuner to be carried with the player. A looping circuit may be included in the system to enable the guitar player to record what is being played and play it back in looping fashion so that the player can accompany their own prior performance. The voice microphone in the guitar strap may also include a looping circuit so that the singer may accompany his or her prior recording, so thereby provide harmonies or other voice effects. A reverb (reverberation) device is provided as an option for the system to provide the popular reverb effect to the amplified sound.

The system of a preferred embodiment includes cables configured with EMI and RFI filters for blocking interference. The cables are provided in various embodiments including cables that carry the stereo signal from the guitar. Other embodiments of the cable split the signal further into four channels. The cables may include a fader and active serial buss in the cable to provide the player with the ability to control devices downstream of the guitar.

The guitar is preferably carried and stored in a case provided as part of the system, the case being formed of light weight and curable high copolymer resin with o-ring seals to provide protection for the instrument. The case may also include wheels with steel ball bearings, folding spring handles, multiple locks, automatic humidity and temperature control valves with an internal vacuum generating device. Additional features on some cases include a GPS tracking circuit for monitoring as many as twelve satellites to identify the location of the case. A sonar alarm may be provided to generate an alarm signal if the case is disturbed or if the alarm is triggered remotely.

The different components of the system may be used together or separately. For example the case may be used to house other instruments than a guitar. The looping circuit can be used in an amplified music or a recording situation without other elements of the system. The cables, guitar, tuner, reverb, and vocal microphone instrument strap may all be used individually with other music performance systems or in various combinations.

The present system enables the performer to play interesting and different sounds by playing the stereo signal through separate channels or by mixing the signals as desired. The elements of the system can also be used to play single channel sounds or the signals may be split or processed to provide multiple channels of sound. The principles of the invention can also be used to provide a guitar or other instrument or music system having more than two channels of sound. For example, a guitar using three pickups can provide three or more individual channels of sound within the scope of the invention. The musician is able to achieve distinctive sounds for performances and recording.

### BRIEF DESCRIPTION OF THE DRAWINGS

FIG. 1 is a circuit diagram of a guitar circuit according to the principles of the present invention;

FIG. 2 is a photograph of safety cables for use in a system with the present guitar;

FIG. 3 is a further photograph of the cables for use in the present system;

FIG. 4 are schematic diagrams of embodiments of the cables according to the present system;

FIG. 5 is a photograph of a guitar tuner mounted within a guitar according to the present invention;

FIG. 6a is a left portion of a circuit diagram for a small amplifier of the present invention;

FIG. 6b is a right portion of the circuit diagram of FIG. 6a;

FIG. 7 is a circuit diagram of a midsize guitar amplifier;

FIG. 8 is a preamplifier substitution for a bass and keyboard amplifier of the present system;

FIGS. 9a and 9b are left and right portions of a circuit diagram of a looping circuit according to the present invention;

FIG. 10 are a schematic diagram and circuit diagrams of an amplifier guitar and bass strap;

FIG. 11 is a schematic diagram of a plate reverb effects device according to the present invention;

FIG. 12 is a photograph of a prototype of the plate reverb effects device for use with an amplified guitar;

FIG. 13 a circuit diagram of a tube amplifier for use in the system of the present invention;

FIG. 14 is a top view of the tube amplifier of FIG. 13;

FIG. 15 is a top front view of a case in the style of the guitar case of the present system;

FIG. 16 is a circuit diagram of a guitar according to another embodiment of the invention; and

FIG. 17 is a schematic diagram and circuit diagram of a strap microphone and looping circuit.

### DETAILED DESCRIPTION OF THE PREFERRED EMBODIMENTS

The invention includes a system for performing and/or recording music as well as the individual elements of the system, a feature of which is the ability to generate two different channels of sound from a single instrument and to process and amplify the channels of sound. Additional features are provided for the musician to generate innovative sounds and tones during the performance and recording, simply the use of the equipment by the musician, protect the instrument from damage, and provide flexibility in use of the equipment.

An aspect of the present invention provides a guitar. The preferred guitar is an all hand crafted semi-hollow body dual circuit guitar with two signal outputs from the dual circuits. The guitar may be a six string guitar, seven string guitar, twelve string guitar or other number of strings. The guitar is preferably an electric guitar with electromagnetic pickups detecting the vibrations of the strings, although it is contemplated to apply the principles of the invention to acoustic and acoustic-electric guitars. Instead of a guitar, a bass guitar or other musical instrument may be used. An exemplary guitar includes a guitar body from a first model edition Mongoose guitar one-of-one built in Devon England 1991, although other guitar designs are of course also possible. The dual circuit, stereo output guitar may include a line of guitars that includes three solid body models. All models include a double octave fret board, loop circuitry that is activated by a loop circuitry switch, and an internal chromatic tuner, in addition to the dual channel signal circuits. Models will be designed for the beginner/intermediate to the advanced professional. All models of the guitar include the stereo circuitry and use the safety cables as described herein.

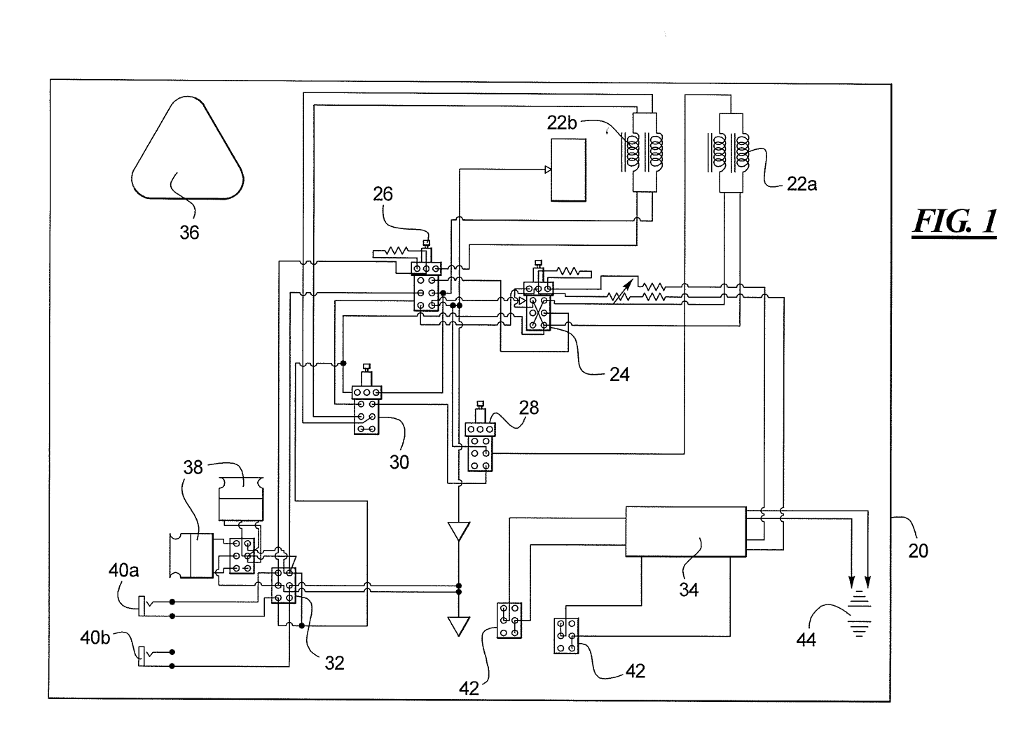

A schematic diagram of the guitar circuit is shown in FIG. 1. The guitar 20 is indicated schematically. The schematic diagram includes Dimarzio pickups 22a and 22b mounted in the guitar 20, preferably model DP-151 and DP-152 pickups. The pickups 22a and 22b have reversed north and south polarity for the coil pairs and are connected as shown to provide a stereo signal from the guitar 20. Potentiometers are provided connected as shown, including a neck volume control 24, bridge volume control 26, neck tone control 28 and bridge tone control 30 as well as a pickup selector switch 32 and a looping circuit 34. Two outputs 40a and 40b are provided for the two sound channels.

The neck volume control 24 controls the looping circuit 34 when activated. Rotating the potentiometer controls the amplitude of the signal from the neck pickups 22a, thereby controlling the neck volume. The potentiometer 24 works both by rotating and by pulling to and out position and pushing to an in position which causes the volume control potentiometer 24 to function as a switch. Pulling the neck switch 24 to the out position puts the neck pickup 22a out of phase when the neck pick up 22a is in a single coil mode. The switch 32 selects which coil will be on. Push to adjust, and pull to standard. The bridge volume control 26 is also a potentiometer that is rotated to adjust the amplitude of the bridge pickup 22b and is switched by pulling and pushing. The bridge control 26 is pulled to switch both pickups 22a and 22b to serial mode, bypassing the selector switch 32 and making the bridge control 26 a master volume control.

In addition to the neck and bridge volume controls 24 and 26, the guitar includes neck and bridge tone controls 28 and 30, both of which are potentiometers that are operated by rotating to adjust the amplitude and that are switched by pulling and pushing. The neck tone control 28 is operated by pulling the switch which puts the neck pickup 22a into a single coil mode and when the bridge tone control 30 is pulled it also switches the bridge pickup 22b to a single coil mode. The bridge tone control 30 is operated by pulling to switch the bridge pickup 22b from a serial humbucker, or humbucking pickup with both coils in series, to a parallel mode with the coils connected in parallel. When the neck tone control 28 is pulled it switches to a single coil. The resulting audio signals are provided to the two outputs 40a and 40b. The controls enable the user to select the signal source provided to each channel.

Also shown in FIG. 1 is an internal chromatic tuner T1 36 that is provided with one or more lights to indicate tuning of the strings on the guitar. The tuner 36 has a microphone for detecting the vibration frequency of the guitar strings as the user plucks each string and an indictor that shows the user whether the plucked string is in tune or not. The tuner 36 is mounted through the upper f hole of the semi-hollow body guitar 20 in a preferred embodiment with a Velcro fastener so that the indicator lights are visible to the user. The internally mounted tuner 36 enables the user to tune the guitar strings without requiring that the user disconnect the electrical connections of the guitar from the amplifier system and connect the electrical connections to the tuner.

FIG. 1 also shows two transistors 38 connected to the selector switch 32 by which variable distortion may be added to the sound output by the guitar 20. Three settings are possible for the distortion circuit, 60 volts, 30 volts and off. The distortion circuit may be bypassed by using the selector switch 32. Two output jacks 40 are provided connected to the selector switch 32 at which the two audio channel signals are output from the guitar 20. The looping circuit 34 is connected to the volume controls 24 and 26 and has mini-toggle switches 42 for controlling recording and playback of the performance data onto and from a memory integrated circuit in the looping circuit. Power is supplied to the looping circuit 34 by a battery 44, such as a nine volt battery.

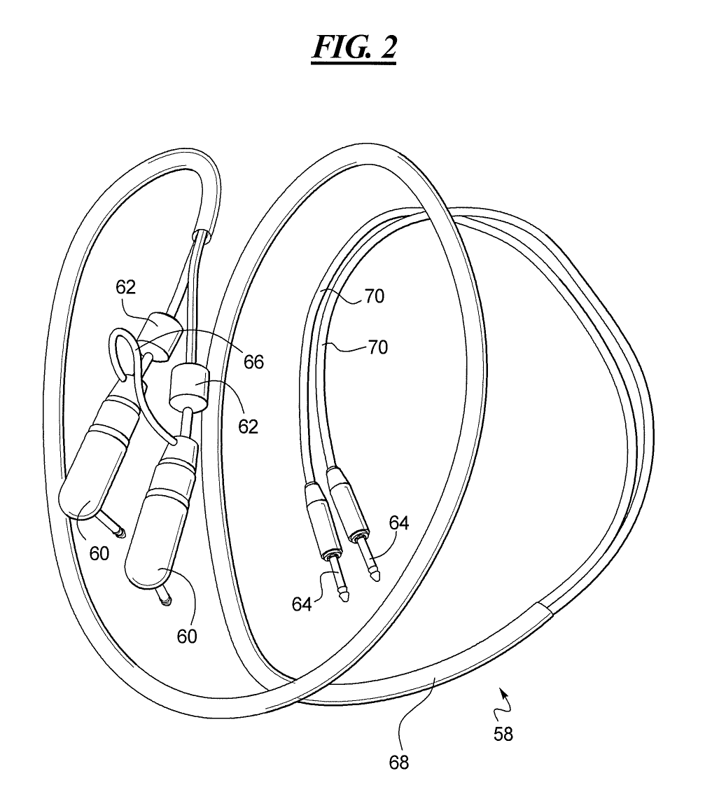

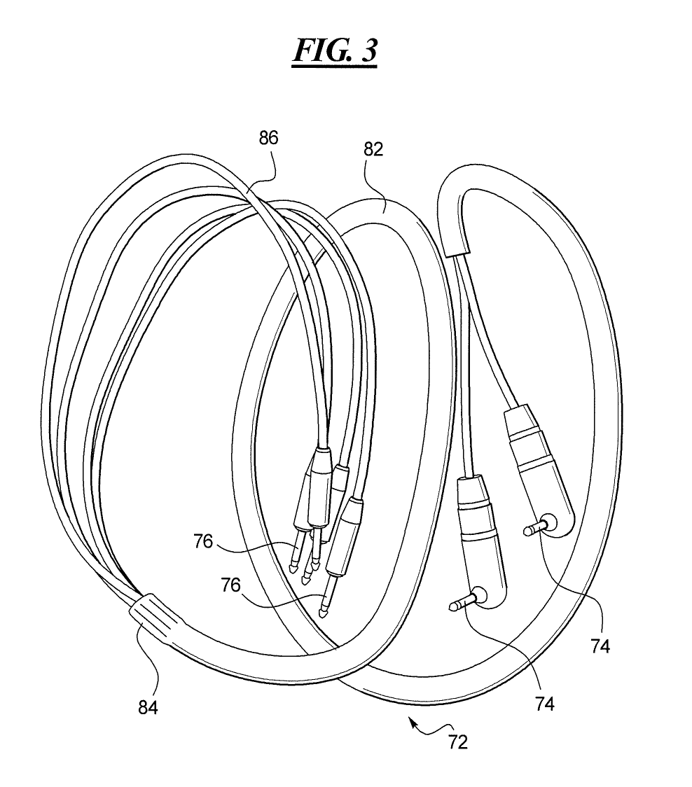

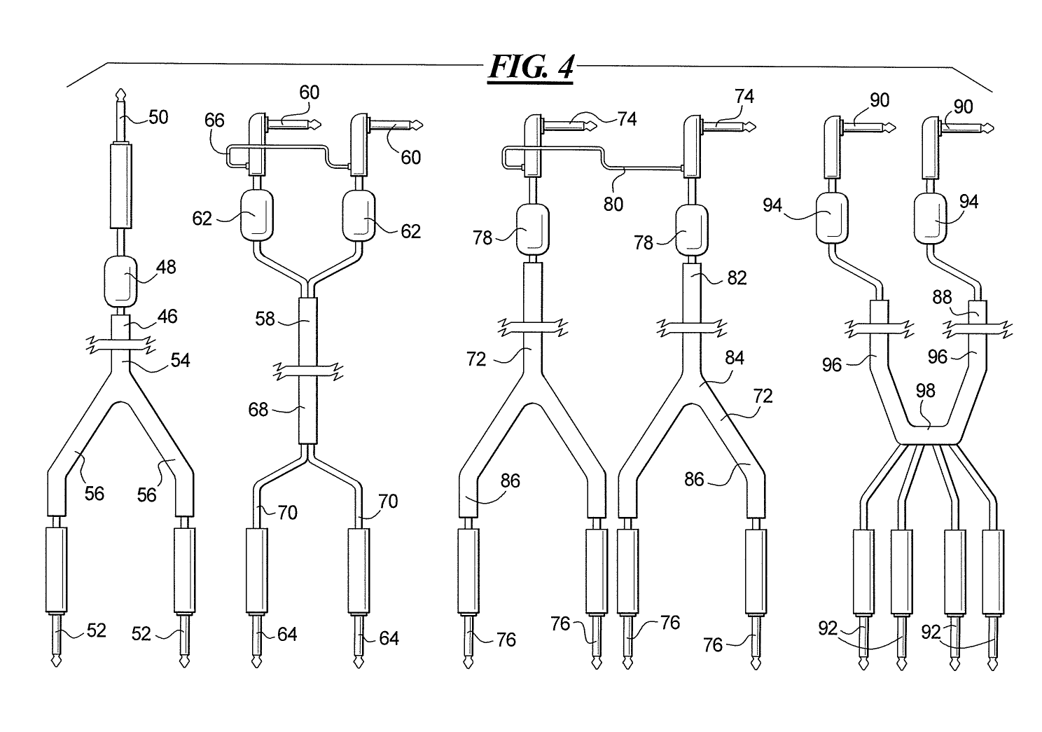

As shown in photographs of FIGS. 2 and 3 and in the circuit diagram of FIG. 4, the preferred system includes a high end set of audio cables for connecting the guitar to the amplifier device. The audio cables include a number of features, such as Neutrik brand jacks with a kill switch and Canare brand cables of the following models; 605 single conductor shielded, L-2T2S dual conductor shielded and L-4E6S four conductor shielded. All cables are grounded together for stereo instrument purposes and contain EMI and REI chokes. All cables will have a “ground snuff” or filter to ground on each end that includes a 220 ohm resistor in series with a 0.002 μF capacitor for extra noise resistance. Some cables feature an active serial buss through which control signals are carried between the guitar and devices connected downstream of the guitar. An impedance fader is mounted in the cable to permit volume control. In one example, the fader operates in a range of 0 to 40 mega ohms.

The audio cables are shown in four models, each using standard ¼ inch connector pins. The first model 46 as shown in FIG. 4 is a single mono line out splitting into two mono outs. A single such cable can be provided where a single channel of sound is desired from the guitar or other instrument, or two such cables may be provided for a stereo guitar as shown in FIG. 1. A single EMI RFI choke 48 is provided near the single mono connector 50 end of the cable. The output splits into two output connectors 52 by splitting the cable 54 into two cables 56 at a position along its length. The two output signal connectors 52 can be connected to different amplifier or effects channels and so produce multiple different channels from the single output.

The second model 58 in FIG. 4 is a stereo cable with two mono inputs 60, each with its own choke 62, and two mono outputs 64. Each half of the cable carries one of the two stereo sound channels from the guitar. A ground jump wire 66 is connected between the two input connectors 60 to provide a common ground for the stereo signals. A heat shrink sleeve 68, which in one embodiment has a length of eight feet, is provided to hold the two cables together along their mid-sections. A section of the separate cables 70 extends from the sleeve 68. The second model 58 is shown in FIG. 2, in which the ground jump wire 66 is seen connecting the input connectors 60.

The third model 72 shown in FIG. 4 is a quadraphonic model which splits the stereo cables from the guitar from two mono inputs 74 into four mono outputs 76. The two inputs 74 are each provided with a choke 78 near the connectors and are connected to one another by a ground jump wire 80. An eight foot long heat shrunk sleeve 82 is provided that leads to a branching junction 84 using L-2T25 cable with braiding at the junction, where two conductors are paired at right angles and the leads are separated at the junction to provide the four outputs. In a preferred embodiment, the separate output leads are provided each in a four foot sleeve 86. The third model 72 is also shown in FIG. 3, including two input connectors 74 and four output connectors 76.

The fourth model 88 of the cables as shown in FIG. 4 splits two mono inputs 90 from the guitar into four stereo outputs 92 allowing for eight signals, that may be used for example for direct recording. The two input connectors 90 are not provided with a ground jump but are provided with the chokes 94 near the inputs. Shielded four conductor cable, such as Canare brand L-4E65 cable, is used as the cable section 96. The input connectors 90 are right angle connectors, as are the inputs of the second and third models. The four signal leads, or plus leads, are paired at the tip of the right angle input connectors 90 in the fourth embodiment. A braiding junction 98 is provided at which the two input leads are connected to one another and split into four dual outputs. One of the signal leads of each output is connected to the tip of the connector pin and the other signal lead is connected to the ring of the stereo output connector pin. The ground is connected to the sleeve of the connector pin. The first output pin has the tip connected to the first input jack and the ring connected to the second input jack. The second output pin has the tip connected to the second input jack and the ring connected to the first input jack. The third output pin is connected the same as the first output pin and the fourth output pin is connected the same as the second output pin.

The audio cables of alternative embodiments include a serial buss with connectors at the ends thereof that are connected to enable the user to control the tone distribution at the output through each cable from the onboard guitar controls. The control that is possible using the cables can be used for both live performance as well as direct recording. Thus, there is shown an assortment of instrument cables to accommodate multiple channel sounds produced by a guitar or other instrument.

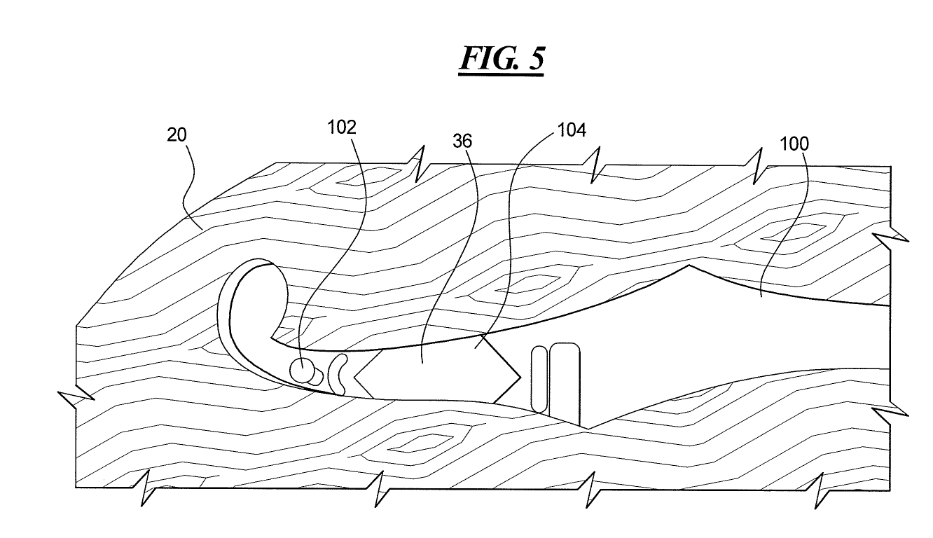

As shown schematically in FIG. 1 and in the photograph of FIG. 5, the chromatic tuner circuit 36 has been built with modifications to enable it to fit inside the f hole 100 of the semi-hollow body guitar 20, and is mounted at a location within the guitar so as to be visible through the f hole using Velcro brand hook and loop fasteners 102. The tuner 36 includes one or more tuning indicator lights 104 that are visible through the f hole 100 so that the user can see the tuning indicators 104 during tuning. This gives the player the ability to tune the instrument 20 without ever having to interrupt performances, sessions, or rehearsals by shutting down the amplifier and plugging in to a standard tuner. No other tuners or tuner cables are needed, giving the player freedom of instant tuning ability.

The system may include a street amplifier for on-street performances. The amplifier was built from a Vanguard case used to house a microphone. A cavity for a speaker was formed by a router tool and an amplification circuit was built inside the amplifier case. The result is a high quality portable instrument amp and four different models have been built. All but the smaller model amplifiers are equipped with a line level output to be daisy chained for maximum frequency distribution. The daisy chain function runs from the larger size amps to the smallest.

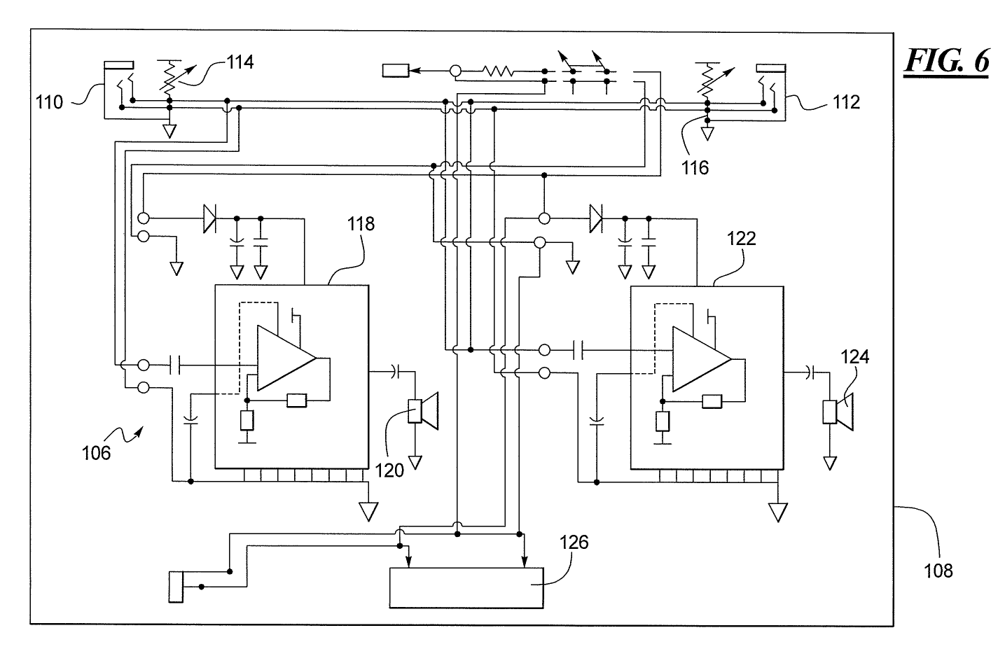

As shown in FIGS. 6a and 66, a small model stereo instrument amplifier, MP3 file player, and karaoke machine 106 is provided. The stereo amplifier carries the two signal channels produced by the guitar described above. The small amplifier 106 is mounted in a case 108, indicated schematically, and features dual input jacks 110 and 112. The input jacks may be of ⅛ inch size as is generally provided for a microphone or may be ¼ inch jacks more common for instrument signals. An independent volume control 114 and 116 is provided for each input. The amplifier produces 6 watts of output power to provide 64 decibels of clear undistorted sound. Higher frequency distribution makes this a complement to a two model set with either midsize guitar or bass model or a large model.

The small amplifier 106 includes an operational amplifier 118 driving the speaker LS1 120 and a second operational amplifier 122 driving the speaker LS2 124, along with associated driving and filtering circuitry. The speakers 120 and 124 are connected in parallel. Power is provided by a 12 volt rechargeable battery 126 that delivers 1.2 amps of current at 12 volts DC.

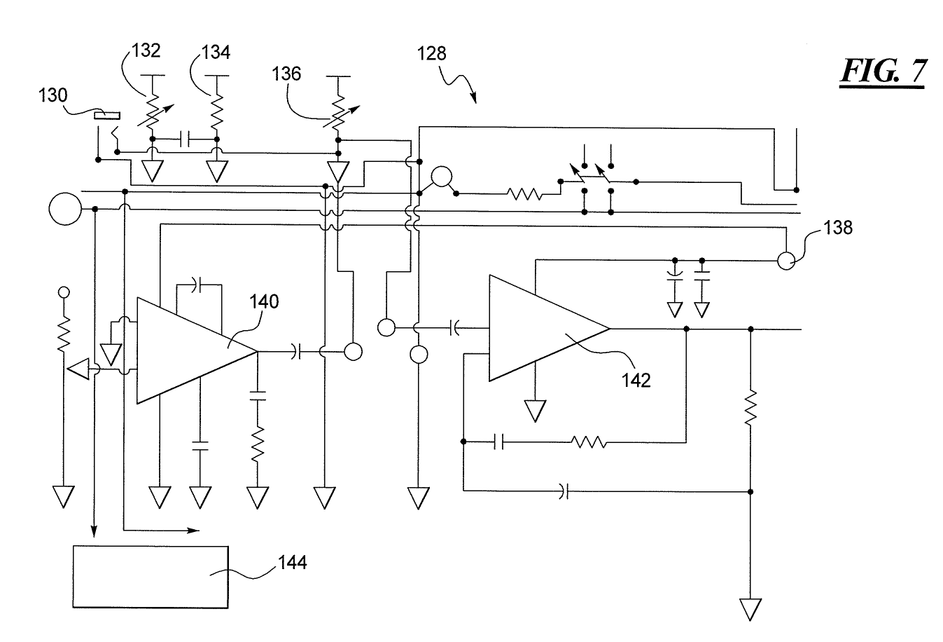

In FIG. 7 a midsize guitar amplifier 128 has a mono ¼ inch input jack 130 with volume 132, tone 134 and master volume 136 controls, and a ¼ inch output 138 with volume control for daisy chain application for all models. The illustrated circuit provides 132 decibels of amplification with a pre-amp stage for gain. Recommended usage of this amplifier is as a set of two amplifiers, one for each of the two sound channels. The amplifier 128 may be used with the small model or set of three with large model or four including a midsize bass model. Two operational amplifiers 140 for the pre-amplifier and 142 for the main amplifier are provided in an embodiment having a 12 volt, 7.5 amp battery 144.

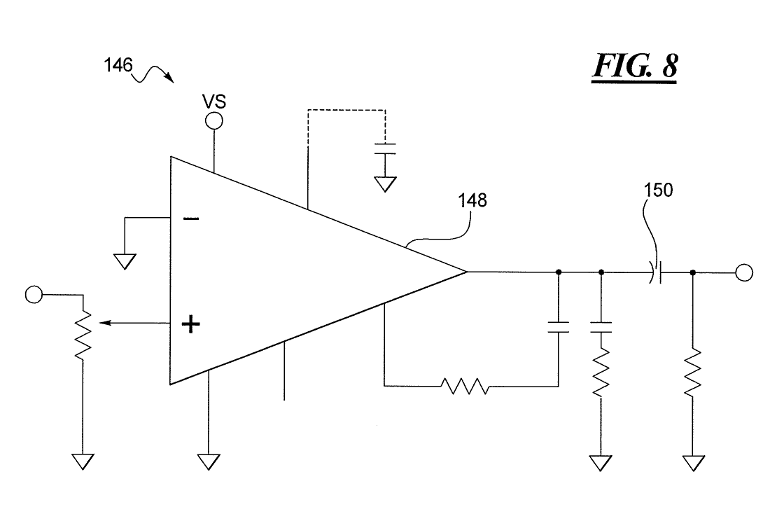

FIG. 8 shows a midsize bass guitar and keyboards amplifier circuit 146, or more precisely, the pre-amplifier substitution section for substitution in the previously illustrated amplifier circuits. The amplifier has a mono design for a bass guitar (and thus has a lower frequency bass enhancement) or other single channel instrument. A ¼ inch input with volume, tone and master volume knobs, and a ¼ inch output with volume control for daisy chain application are provided for all models. An operational amplifier 148 is provided with a filter circuit 150 at the output. The amplifier chip is an IC1-LM386 chip in an exemplary embodiment. The amplifier gain for this model is 132 decibels with a pre-amp stage for gain. Recommended usage of this amplifier is as a set of two for stereo applications with the small model or set of three with large model or as a set of four including midsize guitar model.

A large model stereo amplifier is provided for the system as well. This model has stereo ¼ inch inputs, an XLR microphone input, and a ¼ inch stereo output for daisy chain connection to the other amplifier models. The amplifiers of the present system may be connected to one another in a daisy chain connection by connecting the output of one to the input of another. The large model amplifier provides 218 decibels of clear undistorted sound. The recommended usage of this amplifier is as a set of two with the small model for full frequency spectrum, or as a set of three or four amplifier models.

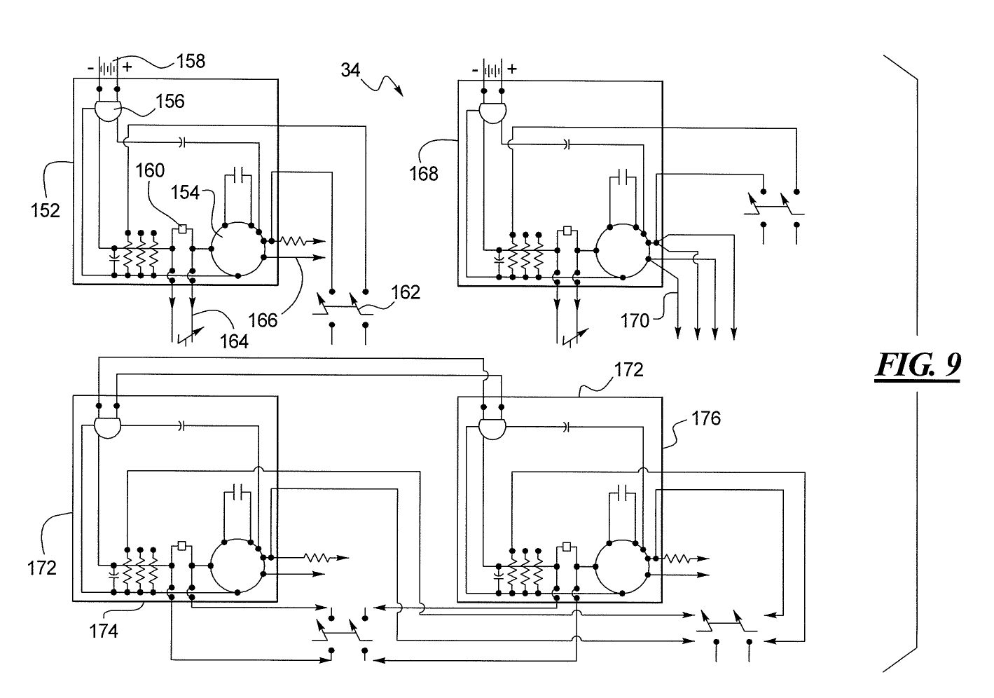

A feature of the present system is a record and play looping circuit 34 as shown in greater detail in FIGS. 9a and 9b, which is mounted within the guitar 20, although it may be provided external to the guitar or other instrument as well. The looping circuit 34 is provided in several models the first of which includes a single output record/play module 152 made up of an analog IC 154 for storage, several resistors, capacitors and one transistor 156 powered by a 9 volt battery 158. The single channel looping circuit may be used to record and play back a single channel of the multiple channel system, or to record the merged signals of a multiple channel system. The record/play input 164 and output 166 is connected to a volume potentiometer, for example at lug 2 and 3 on the guitar or other instrument. An indicator light 160 is provided to indicate that the looping circuit is operating as controlled by a switch 162. The indicator 160 is constant on during recording and blinks during playback. In between the circuit is proper resistance and trimming potentiometer.

The looping circuit models provided in the present system also includes a dual output looping circuit model 168 having elements similar to the looping circuit 152 except that a dual output 170 is provided. In another model, a dual loop and dual output looping circuit 172 is provided, which includes two looping modules 174 and 176. The input signal for recording is provided to both modules and output at both output connectors. The stereo signals of the system are recorded and played back in looping fashion, either one at a time or together.

The looping circuit device allows a user to record what he or she is playing by activating the circuit with an SPST (single pole, single throw) switch to switch the looping circuit either on or off. A recording of the user's performance on the guitar or other instrument is stored in the analog IC memory 154. When the user activates a second SPST switch for playback, the recorded data that has been stored will loop continuously and play through the amplifier system. The looping circuit is connected to a volume potentiometer which enables the user to accompany himself or herself with complete control of the looping volume and the immediate volume of what the user is currently playing.

The looping circuit is a good solution for students to use during practice as well as for professionals who can incorporate arrangements by themselves into their performance without need for other musicians. Four models of the looping circuit have been provided; they are a single loop, single out model 152, a single loop, dual out model 168, a dual loop, single out model, and a dual loop, dual out model 172. The looping circuits shown in FIGS. 9a and 9b include nine volt power supplies 158, a transistor 156 and passive circuit elements to drive an analog memory integrated circuit 154 in which the recorded data is stored. An indicator light 160 is provided connected to the record switch as an indicator to the user that the looping circuit is switched to the record and playback mode. The dual looping circuit 172 includes two transistor/memory chip circuits connected at their outputs.

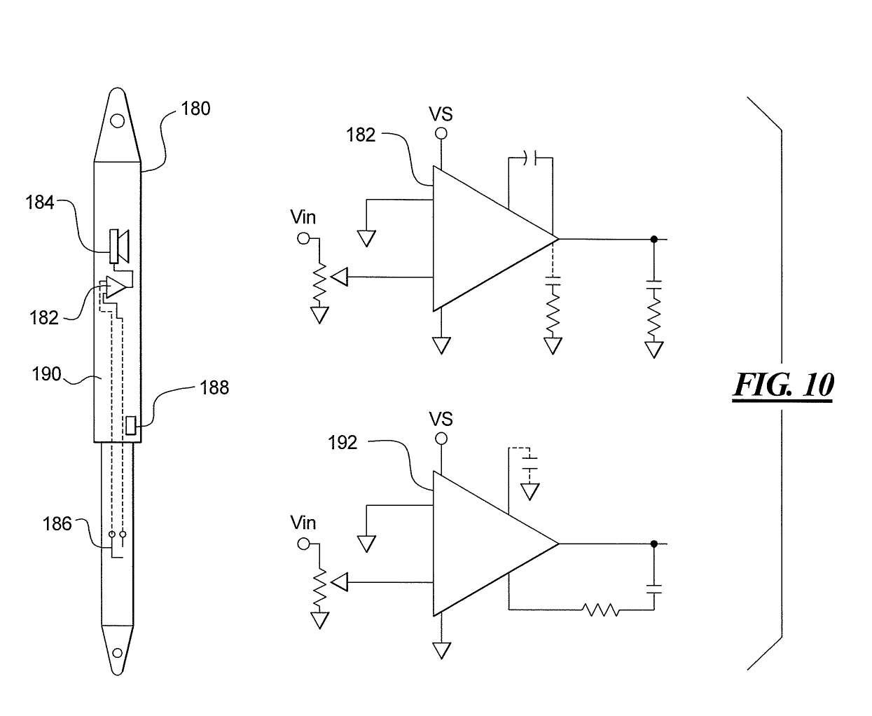

In FIG. 10, is shown a guitar strap 180 with a built-in battery powered amplifier 182 and speaker 184. The guitar strap 180 has a ¼ inch jack 186 at the lower end that is connected to the guitar by a short cable. Wiring in the strap connects the jack to a nine volt battery 188, and an operational amplifier 182 as well as a one watt speaker 184. The speaker, amplifier and battery are in a thickened shoulder pad 190 that is near the user's ear during use, thereby permitting the user to hear his or her performance during practice. In one model, the amplifier 182 is an operational amplifier LM386 that includes biasing elements connected as shown in FIG. 10 to generate an output from a guitar input. The speaker 184 of a preferred embodiment is a two inch diameter speaker mounted facing upward in the shoulder pad of the guitar strap. The circuitry is hidden inside the strap 180, and the battery 188 is attached to the strap using a hook and loop fastener. The illustrated embodiment is a guitar strap amplifier and speaker model. A bass guitar model 192 is also provided with a change in the biasing circuitry for the op amp, as also shown in FIG. 10.

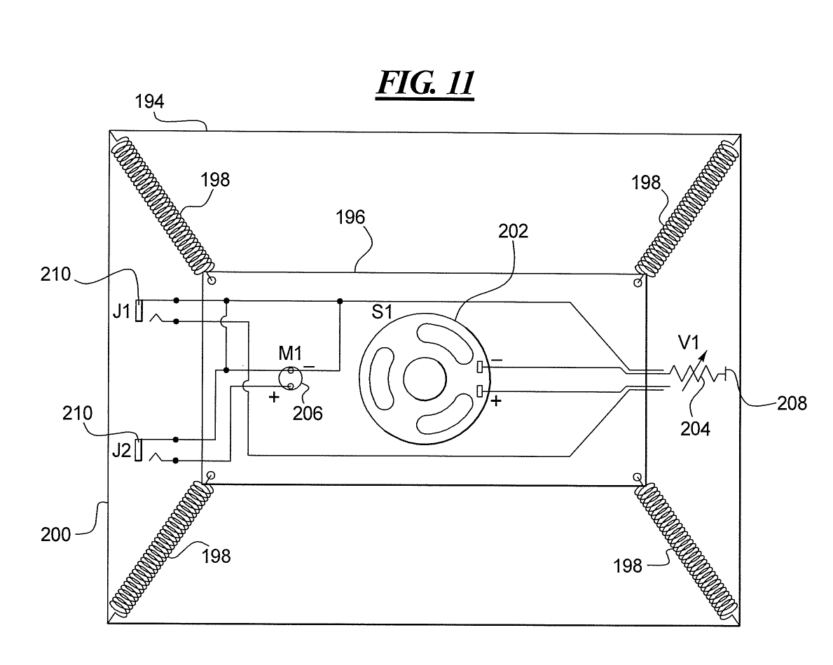

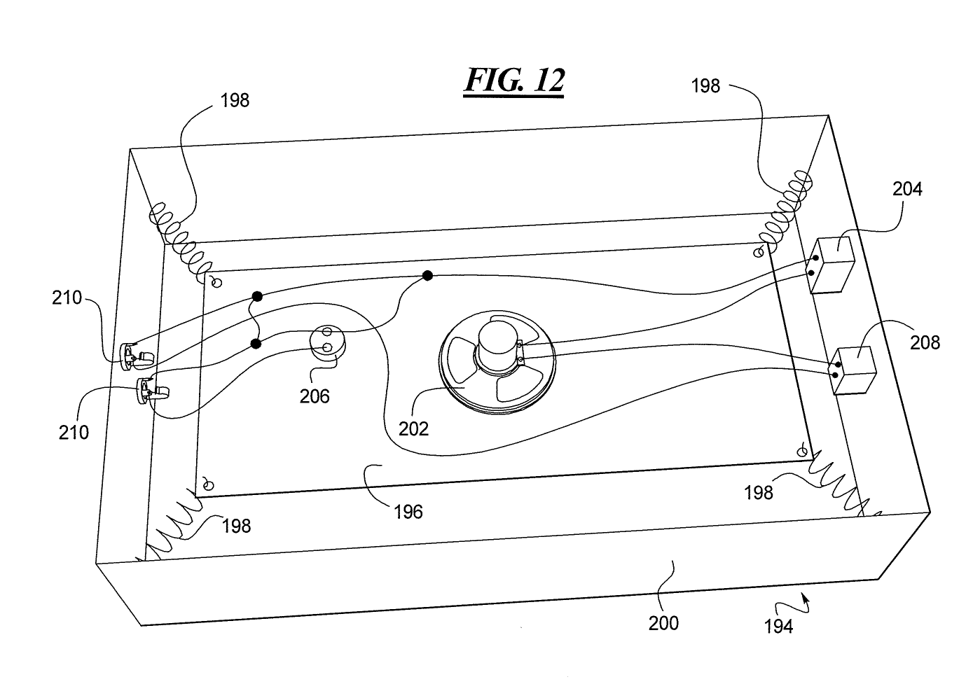

Referring to FIG. 11 and FIG. 12, a plate spring reverb effects apparatus 194 is provided for the system. A reverb effect is frequently used in conjunction with instrument amplifiers and vocalists. Reverbs have been made in spring form, plate form, or by digital processing. In the present reverb effects apparatus, a rectangular piece of sheet metal 196 suspended by four springs 198, one at each corner, within a housing 200. The rectangular sheet metal 196 of preferred embodiments is provided in two sizes, a three inch by six inch size and a four inch by ten inch size. A speaker 202 connected to an input signal is mounted face down on the plate. In one embodiment, the speaker 202 is a two inch, one watt speaker. The speaker 202 is connected to amplifier circuitry through a potentiometer 204, and a small condenser microphone 206 placed face down on the plate 196 connected to the same potentiometer. The speaker 202 connects to output lug 2 and ground; and the microphone 206 connects to input lug 3 and ground. An input jack 208 and two output jacks 210 are provided. The hybrid spring/plate reverb effect device is connected between the instrument, such as the guitar, and the amplifier and speaker system to produce a reverberation effect in the musical performance.

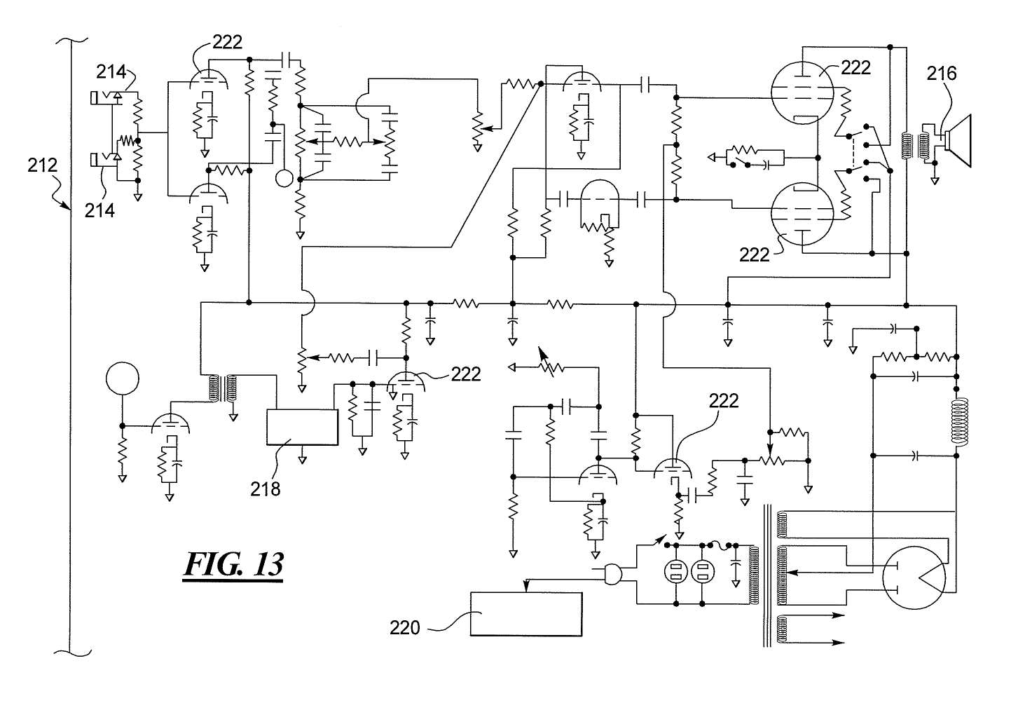

FIG. 13 shows a tube amplifier circuit 212 according to an embodiment of the present invention. The tube amplifier includes two input jacks 214, an output speaker 216 and an assortment of tubes 222 and passive circuit elements connected to provide a clean, clear sound. The principles of operation of the tube amplifier circuit will be understood by those of skill in the art. The amplifier circuit has connected therein a reverb tank 218 which may be the plate and spring reverb as shown herein or may be some other reverb or effects apparatus. Power is provided to the amplifier 212 by a Lady V power supply 220. Details of the Lady V power supply are disclosed in a co-pending application Ser. No. 12/624,057, filed Nov. 23, 2009.

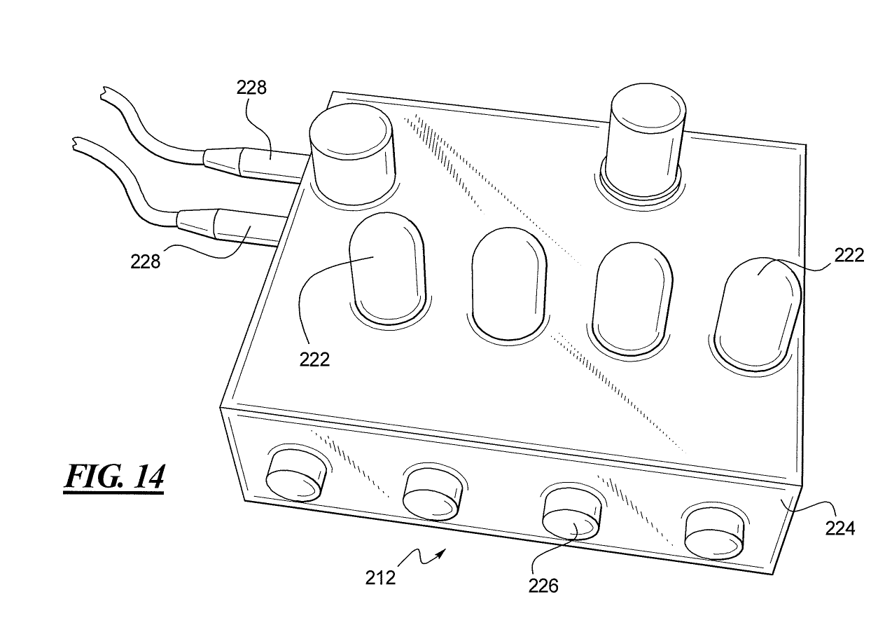

FIG. 14 shows an example of the tube amplifier 212 of FIG. 13, including a plurality of tubes 222 on a mounting board 224 on which is provided knobs 226 for the controls and to which is connected a plurality of cables 228.

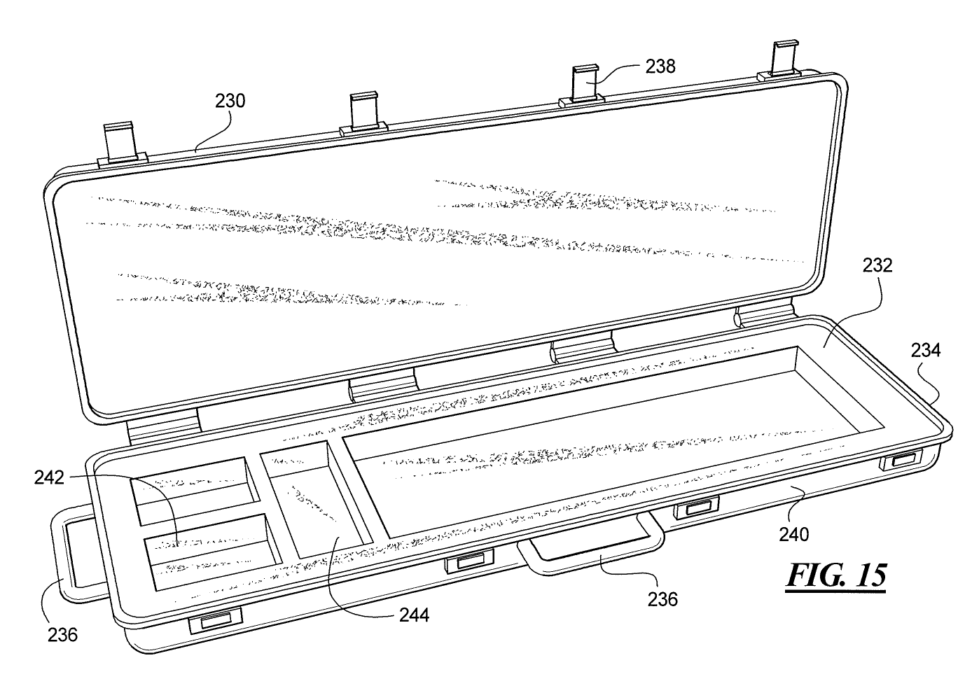

Due to the lack of high end instrument cases available to the public, particularly for high value instruments, such as handmade guitars, and the system includes a case to protect the guitars. The instrument case is modeled on a case 230 as shown in FIG. 15. Features of the case are adapted for the guitar case from a military sniper rifle case manufactured by The Pelican Case Company. The present guitar case is made of ultra light weight and high copolymer resin equipped with an O ring seal 232. The case is fireproof, unbreakable in ordinary usage and corrosion proof, as well as being adequately sealed to be able to float in water. The case features wheels 234 with steel ball bearings, fold-in spring handles 236, multiple locks 238, and automatic humidity and temperature control valves 240 with an internal vacuum. An optional feature of the case is a sonar alarm 242 to alert others to unauthorized access to the case. The alarm may also be able to be set off remotely. A GPS locator circuit 244 is provided as a further optional feature by which the location of the case, and the instrument therein, is determined and transmitted to the owner or to the authorities. Instruments within the case are safe from warping or cracking due to changes in temperature and altitude, which is a common problem with many stringed instruments due to the inadequate cases available on the market. The case will be ATA regulated. The present case is provided in different sizes and shapes for different instruments. The case is ideal for handmade instruments, vintage instruments, symphony instruments (such as cellos and violins including those costing upwards of $20,000.00 to $500,000.00 dollars).

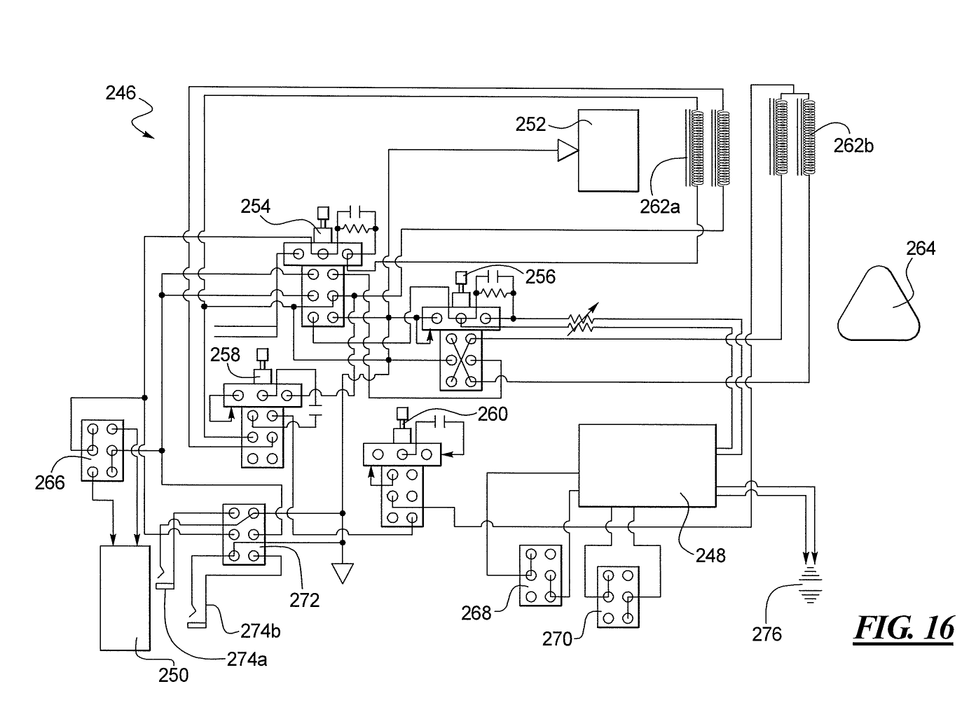

In FIG. 16 is shown an alternative embodiment of the guitar circuit 246. The guitar circuit 246 of FIG. 16 is similar to the circuit of FIG. 1 and provides two output audio channels. In addition to the instrument looping circuit 248 mounted within the guitar, this guitar also includes a vocal looping circuit 250 for recording and loop playback of vocal signals. The circuit also includes a Schaller roller bridge 252. The potentiometers provide bridge volume 254, neck volume 256, bridge tone 258, and neck tone 260. As before the potentiometers also operate as pull/push switched to control connections of various combinations of the pickup coils 262a and 262b. The internal tuner 264 is mounted within the guitar but not connected to the audio signal circuit. Switch 266 is provided to control the vocal looping circuit 250, switches 268 and 270 are provided for the instrument looping circuit 248, and switch 272 controls the signals supplied to the output jacks 274a and 274b. A nine volt battery 276 powers the looping circuit 248.

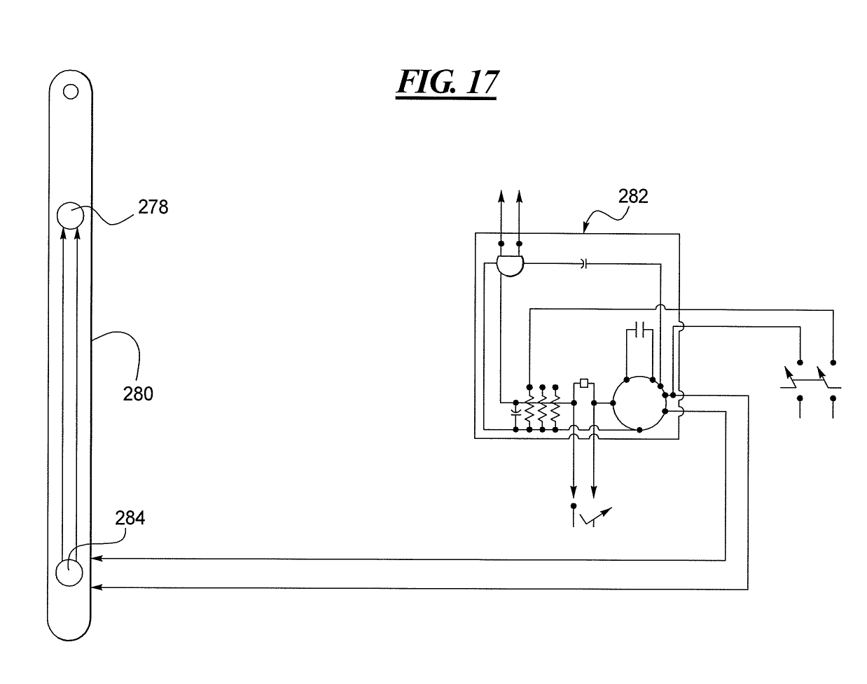

Referring to FIG. 17, the system includes a vocal microphone 278 for use by a performer for singing and speaking during the performance. The microphone 278 is mounted in the guitar strap 280 so that no separate microphone stand is required. In a preferred embodiment, the microphone 278 is connected to a looping circuit 282 to permit recording of the vocal performance and looped playback. In one embodiment, a small condenser microphone 278 is hidden inside the strap 280 and positioned on the shoulder of the user. The output of the microphone is fed through a volume potentiometer and out through the end strap pin 284, where it is attached to one of the record/play (output and input) wires of the looping circuit. The user can sing harmonies, record and store them in the analog IC memory and access them whenever he or she chooses. The strap mounted microphone also allows artists to sing or speak through shoulder strap into the instrument and out through amplifiers and PA equipment. The performer may sing to the audience away from stage microphone.

Thus, there is shown and described a musical performance system including a stereo guitar, guitar strap microphone and speaker, multichannel guitar cords, effects processor, looping circuits, amplifier and guitar case. Each component of the system has improvements and advantages that enable it to be used individually or as part of a system with one or more other components of the system.

Although other modifications and changes may be suggested by those skilled in the art, it is the intention of the inventor to embody within the patent warranted hereon all changes and modifications as reasonably and properly come within the scope of his contribution to the art.

I claim:

1. A system for performing music, comprising:
a guitar having first and second output connectors connected to first and second sound channels;
cabling connected to the first and second output connectors of the guitar for carrying separate sound channel signals;
an amplifier connected to said cabling; and
a speaker connected to the amplifier.

2. A system as claimed in claim 1, further comprising:
a looping circuit connected to the output connectors and including a recording and playback memory.

3. A system as claimed in claim 1, wherein said amplifier is a multiple channel amplifier connected to receive audio signals from separate sound sources in the guitar.

4. A system as claimed in claim 1, further comprising;
a tuner mounted within the guitar and visible through an opening in the guitar body.

5. A system as claimed in claim 1, further comprising:
a guitar strap;
a microphone mounted in the guitar strap; and
a connection wire within the guitar strap connecting the microphone to an audio amplifier.

6. A system as claimed in claim 1, further comprising:
a looping circuit connected to the microphone for looping vocal signals.

7. A system as claimed in claim 1, further comprising:
a guitar strap;
an audio signal input on the strap;
a strap amplifier connected to the audio signal input;
a speaker connected to an output of the strap amplifier.

8. A system as claimed in claim 1, wherein said cabling includes first and second input connectors and first and second output connectors, said cabling including a ground jump connection between said first and second input connectors.

9. A system as claimed in claim 8, further comprising third and four output connectors on said cabling.

10. A system as claimed in claim 1, further comprising:
a spring-plate reverberation apparatus connected between said guitar and said amplifier.
